(19) United States
(12) Patent Application Publication
(10) Pub. No.: US 2010/0300806 A1
(43) Pub. Date: Dec. 2, 2010

(54) 360-DEGREE TREE STAND

(76) Inventor: MIKAEL ASH, Dothan, AL (US)

Correspondence Address: LAW OFFICE OF JERRY D. HAYNES , P.A, P.O. Box 350392, Fort Lauderdale, FL, 33335, US

(21) Appl. No.: 12/476,333

(22) Filed: Jun. 2, 2009

(51) Int. Cl. A01M 31/02

(52) U.S. Cl. 182/113; 182/115

(57) ABSTRACT

The present invention relates to a tree stand for obtaining an elevated view of the landscape that may include: a seat, where said seat may be rotated about a 360-degree range motion; a seat platform, where said seat platform supports the seat of the tree stand; side platforms, where the side platforms are adjoined to the seat platform to form the tree stand; a mechanism to connect the seat platform to the side platforms; a mechanism to secure and abut the tree stand to a tree trunk; and a ladder, where said ladder provides a mechanism to ascend into the tree stand. In one particular embodiment, three connecting rods may connect the seat platform to the side platforms.

### BACKGROUND OF THE INVENTION

1. Field of Invention

The present invention relates to a tree stand capable of providing a 360-degree field of vision.

2. Description of Related Art

Tree stands involve open or a closed platforms used by hunters to position themselves at an elevated height above the terrain. The elevated position allows a hunter to have a better view of game that he may be hunting at the time. Generally three types of tree stands exist. One type of tree stand involves a climbing tree stand that includes a stand platform and may be mounted upon a tree by using wraps, cable or bolting thereupon. A climbing tree stand requires a hunter to climb a tree in order to position himself within the tree stand while hunting. Another type of a tree stand is a ladder tree stand when a ladder is included and attached to the platform to the tree stand. The ladder provides a means for the hunter to position himself on the tree stand without the necessity of climbing a tree. Ladder tree stands may include a seat and platform and may be connected permanently to a tree. Yet another type of tree stand includes a hanging tree stand that is similar to a ladder tree stand, however, the tree stand is connected to the tree by hanging it with the use of cable or chains to a desired height. A hunter may use a ladder to access the hanging tree stand or in some instances steps or mounted upon the tree itself to allow the hunter to ascend the tree and position himself within the hanging tree stand.

Although tree stands are very helpful and provide the hunter with an elevated view of the landscape, some shortcomings exist with respect to the present tree stands that are available. Many tree stands do not permit the hunter to have a full peripheral view of the landscape. Many times the hunter is restricted to facing in one position over a 180-degree range of sight. Although some tree stands exist that include a completely circular platform that surrounds the entire tree trunk, the hunter must use the stand upon these tree stands and therefore does not have a seated position that is advantageous for the long periods of time which may be spent in a tree stand. Therefore, a need exists for a tree stand that allows a hunter to comfortably sit and have a 360-degree field of view from the seated position.

### SUMMARY OF THE INVENTION

The present invention relates to a tree stand for obtaining an elevated view of the landscape comprising: a seat, where said seat may be rotated about a 360-degree range motion; a seat platform, where said seat platform supports the seat of the tree stand; side platforms, where the side platforms are adjoined to the seat platform to form the tree stand; a means to connect the seat platform to the side platforms; a means to secure and abut the tree stand a tree trunk; and a ladder, where said ladder provides a means to ascend into the tree stand. In one particular embodiment, three connecting rods may provide the means to connect the seat platform to the side platforms. In another particular embodiment, the tree stand may include jagged edges on the abutting sides of the seat platform and side platforms and ratchet straps within the platform as a means to secure and abut the tree stand to a tree.

The seat of the present invention may include a mounting post, where the mounting post connects to a seat post extending from the seat platform. The mounting post may control the degree of rotation of the seat.

### DESCRIPTION OF DRAWINGS

FIG. 1 provides a perspective view of the tree stand according to the present invention.

FIG. 2 provides a top view of the tree stand according to the present invention.

FIG. 3 depicts the side view of the seat utilized with the tree stand according to the present invention.

FIG. 3A depicts a center post for mounting the seat utilized with the present invention.

FIG. 4A depicts a view of the side platforms utilized with the present invention.

FIG. 4B depicts a seat-mounting platform utilized with the present invention.

### DETAILED DESCRIPTION

The present invention relates to a tree stand that provides a swivel chair positioned on one side of the tree that rotates over a 360-degree range of motion. The swivel chair enables the hunter to have a 360-degree view of the landscape without leaving the seated position while in the tree stand. The tree stand according to the present invention includes a ladder for access and a platform that surrounds three sides of the tree to provide the hunter with additional room for maneuvering on the tree stand.

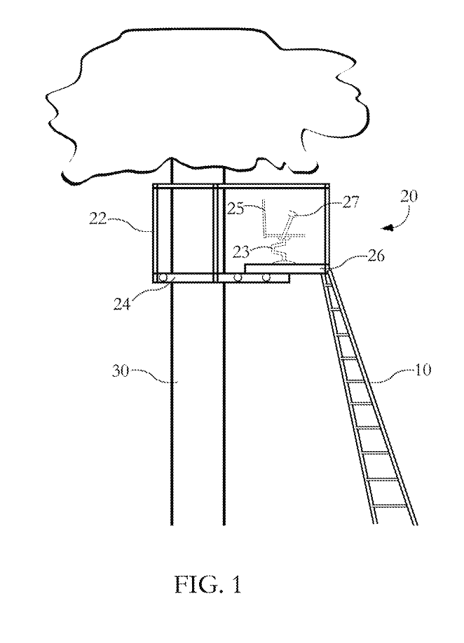

FIG. 1 depicts a perspective view of the tree stand 20 according to the present invention. The tree stand 20 includes a ladder 10 that provides access to the tree stand 20. A seat platform 26 is connected to additional platform 24 that surrounds three sides of the tree. Railing 22 may also be included with the tree stand 20. A seat 25 is mounted on the seat platform 26. The seat 25 swivels about the mounting post 23. The mounting post 23 supports the seat 25 and enables the seat 25 to rotate in a 360-degree range of motion. Further included on the seat 25 is a resting post 27 that can be utilized as a shooting position for the hunter.

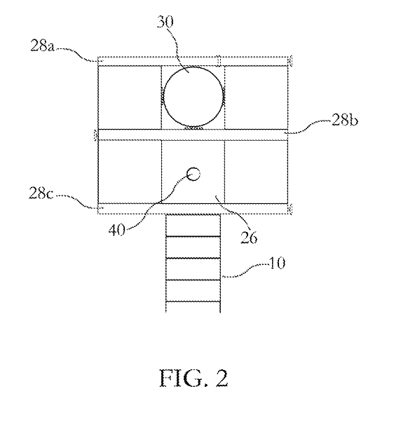

FIG. 2 depicts a top view of the tree stand 20 according to the present invention. The top view includes the side platforms 24 attached to the seat platform 26. Three connecting rods 28a, 28b, 28c connect the platforms together and may be tighten at the ends thereof to secure the platform assembly into place. Also seen at the top view is a seat mounting post 40 in the center of the seat platform 26. The ladder 10 ascends to the front portion of the tree stand 20 and allows the hunter to enter into the tree stand directly into the seat provided. As can be seen from the top view, the tree trunk is surrounded on three sides by the side platforms 24 and seat platform 26.

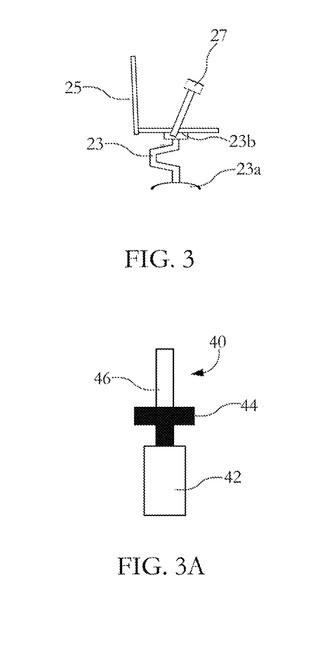

FIG. 3 shows a detailed view of the seat 25 according to the present invention. The seat 25 includes the mounting post 23. The mounting post 23 connects to the bottom of the seat 25 at a rotating point 23b. The mounting post 23 connects to the seat post 40 and includes a base portion 23a that encloses mounting 23 and seat post 40 connection. The rotation of the mounting post 23 may be controlled and be set at any point from 0 to 360 degrees by adjusting the mounting post 23.

FIG. 3A depicts a detailed view of the seat post 40 for the seat 25. The seat post 40 includes an upper arm 46, a rubber sleeve 44 and an outer post 42. The outer post 42 fits within a cavity of the seat platform 26. The seat post 40 connects to the mounting post 23 of the seat. It provides a firm stable connection for the seat 25 and enables the seat to rotate throughout the 360 degrees range of motion.

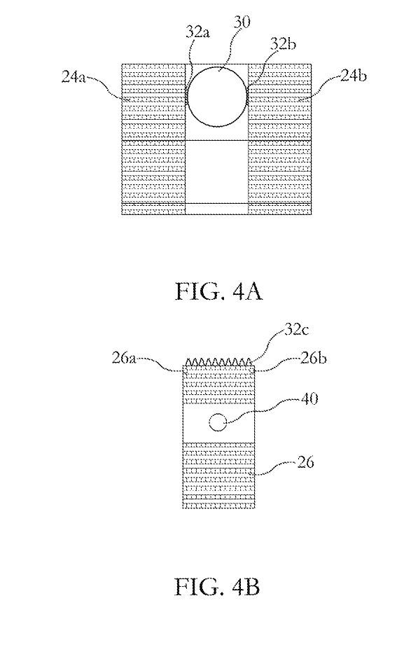

As stated above, the tree stand 20 according to present invention includes seat platform 26 and two side platforms 24a, 24b. A detailed top view of these platforms 24a, 24b is provided in FIGS. 4A and 4B. As noted in FIG. 4A, the side platforms 24a and 24b abut the tree 30 and include jagged connecting surfaces 32a, 32b on each a respective side of the tree trunk 30. The jagged edges 32a, 32b abut the tree trunk and firmly secure the side platforms 24a, 24b in contact with the tree. The seat platform 26 includes two holes 26a, 26b for the insertion of ratchet straps which tighten the position of the seat platform in contact with the tree trunk 30. The seat platform 26 is adjoined to the side platforms 24a, 24b through the use of the connecting rods 28a, 28b, 28c that are depicted in FIG. 2.

Once the platforms are fully assembled and the tree stand 20 is in place, the hunter may mount the tree stand 20 via the ladder 10 and then maneuver for hunting purposes in the seat 25. Due to the additional side platforms 24a and 24b, the hunter may also stand and maneuver them to the side platforms and achieve a 360-degree field of the view of the terrain. This 360-degree field of view is also capable of being obtained while seated in the seat 25 which rotates about a 360 degree range of motion.

The tree stand 20 according to the present invention therefore obviates some of the drawbacks of the current tree stands presently in use. The tree stand 20 according to the present invention optimizes game hunting results by providing the hunter with a 360-degree range of motion in an open framed platform that is secured upon three sides of a tree. Normally a hunter must utilize a tripod type of tree stand in order to obtain a 360-degree field of view as enabled by the present invention. However, the hunter may be able to adjust the height of this tree stand to higher heights than possible with a tripod type of tree stand. Further, the field of view is adaptable while being seated in the seat provided on the tree stand according to the present invention. The hunter may maintain the position in the tree stand for an extended period of time as is usually necessary on a hunting expedition. The platform of the present invention is extended upon three sides of the tree with the inclusion of the seat available for the hunter.

What is claimed is:

1. A tree stand for obtaining an elevated view of the landscape comprising:
a. a seat, where said seat may be rotated about a 360-degree range motion;
b. a seat platform, where said seat platform supports the seat of the tree stand;
c. side platforms, where the side platforms are adjoined to the seat platform to form the tree stand;
d. a means to connect the seat platform to the side platforms;
e. a means to secure and abut the tree stand to a tree trunk; and
f. a ladder, where said ladder provides a means to ascend into the tree stand.

2. The tree stand according to claim 1, where the means to connect the seat platform to the side platforms includes three connecting rods.

3. The tree stand according to claim 1, where the means to secure the tree stand include jagged edges on the abutting sides of the seat platform and side platforms and ratchet straps within the platform.

4. The tree stand according to claim 1, where the seat includes a mounting post, where said mounting post connects to a seat post extending from the seat platform.

5. The tree stand according to claim 4, where the mounting post controls the degree of rotation of the seat.

6. The tree stand according to claim 5, where the seat includes a base portion that encloses a lower portion of the mounting post and the seat post.

7. The tree stand according to claim 4, where the mounting post and seat post are positioned in the center of the seat platform.

8. The tree stand according to claim 1 where the seat platform and side platforms surround three sides of the tree.

9. The tree stand according to claim 1, where the tree stand includes a railing surrounding the side and seat platforms.

10. The tree stand according to claim 1, where the seat includes a resting post, where said resting post provides a shooting position for the hunter.

11. The tree stand according to claim 3, where the seat platform includes two holes for the insertion of the ratchet straps.
